(19) United States
(12) Patent Application Publication
(10) Pub. No.: US 2017/0285770 A1
(43) Pub. Date: Oct. 5, 2017

(54) ENHANCED USER INTERACTION WITH A DEVICE

(71) Applicant: University of Newcastle Upon Tyne, Newcastle upon Tyne, Tyne and Wear (UK)

(72) Inventors: Jonathan Hook, Newcastle upon Tyne, Tyne and Wear (UK); Patrick Olivier, Newcastle upon Tyne, Tyne and Wear (UK)

(73) Assignee: University of Newcastle Upon Tyne, Newcastle upon Tyne, Tyne and Wear (UK)

(21) Appl. No.: 15/104,878

(22) PCT Filed: Dec. 19, 2014
(86) PCT No.: PCT/GB2014/053810

§ 371 Date: Jun. 15, 2016

(51) Int. Cl. G06F 3/0346; G06F 3/0484; G06F 3/0488

(52) U.S. Cl. CPC G06F 3/0346; G06F 3/04883; G06F 3/04842; G06F 2203/0381

(57) ABSTRACT

A method, for a device, for enhancing user interaction with the device is provided. The method comprises the steps of: receiving a user input; receiving a signal comprising information indicating a motion and/or orientation of a sensor during a period of time occurring before, during, and/or after occurrence of the user input; performing an operation depending on the user input and the motion and/or orientation of the sensor.

### BACKGROUND OF THE INVENTION

### Field of the Invention

The present invention relates generally to a technique for enhancing user interaction with a device. For example, certain exemplary embodiments of the present invention provide a method, apparatus and/or system in which a device (e.g. a touch sensitive device) performs an operation depending not only on a user input (e.g. a touch gesture) received by the device, but also on the motion and/or orientation of a sensor (e.g. a sensor unit worn or held by the user while applying the input) during a period of time occurring before, during and/or after occurrence of the user input.

### Description of the Related Art

Touch sensitive devices are becoming increasingly common and popular. For example, various types of device, including mobile telephones, tablet computers, and laptop computers, are typically provided with a touch sensitive input unit including an input surface, for example in the form of a touch panel or touch screen. A user may interact with a touch sensitive device by applying a touch-based input (sometimes referred to as a touch gesture) to the input unit. A touch gesture is typically applied to the input unit using an input object, for example a finger or stylus.

In conventional touch sensitive devices, a touch gesture may be characterised by one or more different types of basic action, including, for example: (i) a touch-down action, in which an input object not in contact with the touch surface makes contact with the touch surface, (ii) a touch-release action, in which an input object in contact with the touch surface releases contact with the touch surface, and (iii) a touch-movement action, in which the touch position of an input object moves while contact with the touch surface is maintained. Various types of touch gesture comprise one or more of these actions in various combinations. For example, a “tap” gesture comprises a touch-down followed by a touch-release, and a “drag” gesture comprises a touch-down followed by a touch-movement followed by a touch-release. Some touch gestures may be characterised by a multi-touch, in which the touch surface is touched at two or more points simultaneously. For example, a “pinch” gesture comprises a touch-down applied at two different touch points followed by a touch-movement of each touch point towards each other. Some touch gestures may be characterised by a combination of two or more touch gestures. For example, a “double-tap” comprises two tap gestures in quick succession. A gesture may be characterised by one or more parameters associated with the various actions, for example the coordinates of a touch-down and/or touch-release, the speed and/or direction of a touch-movement, the duration of a touch, the time between actions, and so on.

As the popularity of touch sensitive devices increases, there is a greater demand for enhanced interactivity between users and their devices. Although touch gestures supported by conventional touch sensitive devices provide a rich set of gestures, there is nevertheless an increasing demand for new ways for a user to interact with a device.

Some techniques broaden the range of touch gestures by allowing touch gestures to be defined based on touch pressure. The touch pressure may be measured, for example, by a pressure sensor incorporated into the touch surface and/or the input object, and/or by using a capacitive-based input unit. Defining touch gestures based on touch pressure allows, for example, a device to distinguish between a “touch” gesture (characterised by a touch pressure less than a threshold) and a “push” gesture (characterised by a touch pressure greater than a threshold). However, this type of technique requires constant contact between the input object and the input surface, and provides only limited expressive range in the Z-axis (i.e. the axis perpendicular to the touch surface). This type of technique also requires specialist hardware.

Another technique broadens the range of touch gestures by allowing touch gestures to be defined based on finger pose. However, this technique requires special or dedicated hardware that may not be available in many types of device, and may be expensive to implement.

Accordingly, what is desired is a technique for enhancing user interaction with a device that provides a wide range of additional interactions, utilizes relatively low-cost technology, is technology independent, and may be used with a wide variety of devices with relatively little or no modifications required.

### SUMMARY OF THE INVENTION

It is an aim of certain exemplary embodiments of the present invention to address, solve and/or mitigate, at least partly, at least one of the problems and/or disadvantages associated with the related art, for example at least one of the problems and/or disadvantages described above. It is an aim of certain exemplary embodiments of the present invention to provide at least one advantage over the related art, for example at least one of the advantages described below.

The present invention is defined by the independent claims. Advantageous features are defined by the dependent claims.

In accordance with an aspect of the present invention, there is provided a method, for a device, for enhancing user interaction with the device, the method comprising the steps of: receiving a user input; receiving a signal comprising information indicating a motion and/or orientation of a sensor during a period of time occurring before, during, and/or after occurrence of the user input; and performing an operation depending on the user input and the motion and/or orientation of the sensor.

In accordance with another aspect of the present invention, there is provided a device for enhancing user interaction with the device, the device comprising: an input unit for receiving a user input; a receiver for receiving a signal comprising information indicating a motion and/or orientation of a sensor during a period of time occurring before, during, and/or after occurrence of the user input; and a processor for performing an operation depending on the user input and the motion and/or orientation of the sensor.

In accordance with an aspect of the present invention, there is provided a method according to any one of claims 1 to 29.

In accordance with another aspect of the present invention, there is provided a device according to any one of claims 30 to 58.

In accordance with another aspect of the present invention, there is provided a system according to any one of claims 59 to 62.

In accordance with another aspect of the present invention, there is provided a computer program comprising instructions arranged, when executed, to implement a method, device and/or system in accordance with any aspect or claim disclosed herein.

In accordance with another aspect of the present invention, there is provided a machine-readable storage storing a computer program according to the preceding aspect.

Other aspects, advantages, and salient features of the present invention will become apparent to those skilled in the art from the following detailed description, which, taken in conjunction with the annexed drawings, disclose exemplary embodiments of the present invention.

### BRIEF DESCRIPTION OF THE DRAWINGS

The above and other aspects, and features and advantages of certain exemplary embodiments and aspects of the present invention will be more apparent from the following detailed description, when taken in conjunction with the accompanying drawings, in which:

FIG. 1 illustrates a system according to an exemplary embodiment of the present invention; and

FIG. 2 illustrates a method according to an exemplary embodiment of the present invention.

### DETAILED DESCRIPTION OF EXEMPLARY EMBODIMENTS

The following description of exemplary embodiments of the present invention, with reference to the accompanying drawings, is provided to assist in a comprehensive understanding of the present invention. The description includes various specific details to assist in that understanding but these are to be regarded as merely exemplary. Accordingly, those of ordinary skill in the art will recognize that various changes and modifications of the embodiments described herein can be made without departing from the scope of the present invention, as defined by the claims.

The terms, words and phrases used in the following description and claims are not limited to the bibliographical meanings, but, are used to enable a clear and consistent understanding of the present invention.

In the description and Figures of this specification, the same or similar features may be designated by the same or similar reference numerals, although they may be illustrated in different drawings.

Detailed descriptions of structures, constructions, functions or processes known in the art may be omitted for clarity and conciseness, and to avoid obscuring the subject matter of the present invention.

Throughout the description and claims of this specification, the words “comprise”, “include” and “contain” and variations of the words, for example “comprising” and “comprises”, means “including but not limited to”, and is not intended to (and does not) exclude other features, elements, components, integers, steps, processes, operations, characteristics, properties and/or groups thereof.

Throughout the description and claims of this specification, the singular forms “a,” “an,” and “the” include plural referents unless the context dictates otherwise. Thus, for example, reference to “an object” includes reference to one or more of such objects.

Throughout the description and claims of this specification, language in the general form of “X for Y” (where Y is some action, process, activity, operation or step and X is some means for carrying out that action, process, activity, operation or step) encompasses means X adapted, configured or arranged specifically, but not exclusively, to do Y.

Features, elements, components, integers, steps, processes, operations, functions, characteristics, properties and/or groups thereof described in conjunction with a particular aspect, embodiment or example of the present invention are to be understood to be applicable to any other aspect, embodiment or example described herein, unless incompatible therewith.

The methods described herein may be implemented in any suitably arranged apparatus or system comprising means for carrying out the method steps.

In the following description, for convenience of description, all references to “motion” include references to “motion and/or orientation” unless otherwise indicated, or unless the context clearly dictates otherwise.

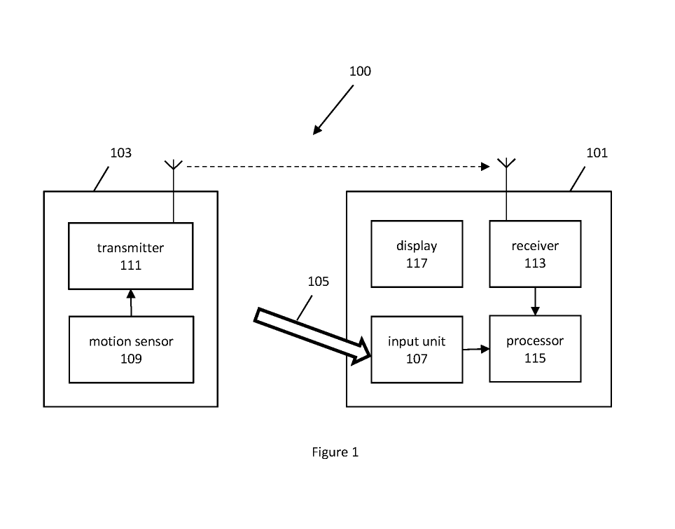

FIG. 1 illustrates a system according to an exemplary embodiment of the present invention. The system 100 comprises a device 101 (e.g. a user device) and a motion unit (or sensor unit) 103. The device 101 and the motion unit 103 may be provided as separate devices (i.e. the motion unit 103 is external to the device 101 and physically separate from the device 101) such that the motion of the motion unit 103 (and the motion of a motion sensor 109 comprised in the motion unit 103) is independent of any motion of the device 101. The device 101 is configured for receiving an input (e.g. a touch gesture) applied by a user. The input may be applied using an input object 105 (e.g. a finger or stylus). As described in greater detail below, the device 101 performs an operation depending on the user input and motion of the motion unit 103 during a period occurring before, during and/or after occurrence of the user input. For example, in certain embodiments, the result of applying the input (e.g. the manner in which the device 101 processes the input) depends on the motion of the motion unit before, during and/or after the input is applied.

The motion unit 103 may be incorporated into, or attached to, the input object 105, thereby allowing the user to influence the result of the input by suitable motion of the input object. Alternatively, the motion unit 103 may be physically separate from the input object 105. For example, the motion unit 103 may be attached to, or held by, a body part of the user, thereby allowing the user to influence the result of the input by suitable motion of the body part. Accordingly, in embodiments of the present invention a single type of input applied to the device 101 may give rise to a multiplicity of outcomes depending on the measured motion of the motion unit 103.

In certain exemplary embodiments described below, a touch input is used as an example of the input. However, the skilled person will appreciate that the present invention is not limited to this specific example, and that an input may comprise any other suitable type of input. For example, the input may comprise any suitable type of input based on an interaction between the input object 105 and the device 101. The interaction may comprise direct physical interaction or contact between the input object 105 and the device 101 (e.g. a touch or actuation), and/or an interaction based on a detected or sensed proximity between the input object 105 and the device 101. For example, in certain embodiments, a user input may comprise actuation of a physical input element, for example a button, key, switch, slider and the like. The physical input element may form part of the device 101. In certain embodiments a user input may comprise a proximity input based on detection of an object (e.g. a user's hand or other input object) located close to, but not in direct physical contact with, a device (e.g. the device 101). Whatever form of input may be used, a device (e.g. the device 101) may perform an operation depending not only on the user input, but also on motion of a motion unit occurring before, during and/or after occurrence of the input. The embodiments described herein may be modified accordingly.

As illustrated in FIG. 1, the motion unit 103 comprises a motion sensor 109 for measuring motion of the motion unit 103, and a transmitter 111 for transmitting motion data generated by the motion sensor 109 to the device 101. The device 101 comprises a display 117 for displaying a user interface (e.g. a Graphical User Interface, GUI), an input unit 107 for receiving a touch input, a receiver 113 for receiving motion data from the motion unit 103, and a processor 115 for performing various operations of the device 101. For example, the processor 115 performs one or more operations according to one or more touch inputs received by the input unit 107. The processor 115 may also analyse the motion data received from the motion unit 103 to determine one or more characteristics of the motion represented by the motion data. The processor then performs an operation depending on a touch input and the determined characteristics of the motion. The operation performed may also depend on the timing of the motion relative to the input, for example depending on whether the motion occurs before, during and/or after the input (i.e. any combination of before, during and after). The processing performed by the processor 115 will be described in greater detail below.

The device 101 and/or the motion unit 103 may additionally comprise a storage unit (not shown), for example for storing data (e.g. motion data and/or input data) used or generated during operation, and/or software (e.g. operating system or code) used to control various operations and processes.

The device 101 may comprise any suitable type of device configured for receiving a touch input, for example a portable terminal or handheld device (e.g. a mobile telephone, personal organiser, tablet computer and the like), a computer (e.g. a desktop computer, laptop computer and the like), a gaming device, a single-functional or multi-functional automotive control panel (e.g. incorporating one or more of: a satellite navigation system, for example Global Positioning System (GPS), communications, vehicular information systems and audio controls), or any other type of device configured to receive a touch input (e.g. a touch table, television, home appliance, Automated Teller Machine (ATM), industrial or medical device control system interface, and the like).

The input unit 107 may comprise any suitable means for receiving a touch input. For example, the input unit 107 may comprise a touch panel or a touch screen. The input unit 107 may additionally or alternatively comprise one or more other types of sensor or input means for detecting a touch input, for example based on sound or images, or variations in a magnetic or electric field. A surface of the device (e.g. a surface of the input unit 107) that is used to receive or detect a touch input input may be referred to as an input surface.

The touch input may comprise any suitable type of input or gesture, for example a touch, double touch (or tuple touch), tap, short touch, long touch, drag, sweep, flick, pinch, trace, figurative trace, and the like.

The input object 105 may comprise any suitable means for applying a touch input, for example a finger, hand or other body part of the user, a stylus, a pen, and the like.

The motion unit 103 is configured such that, during use, the user may move and/or orientate the motion unit 103 before, during and/or after applying a touch input to the input unit 107. In certain embodiments, the motion unit 103 may be arranged, during use, to co-move with the input object 105 such that the motion of the motion unit 103 correlates relatively closely with motion of the input object 105. Alternatively, or additionally, in certain embodiments, the motion unit 103 may be arranged, during use, such that the motion unit 103 and the input object 105 may be moved independently. For example, the motion unit 103 may be incorporated into, or attached to, the input object 105. Alternatively, the motion unit 103 may be attached to a body part of the user (e.g. the user's wrist or finger). For example, the motion unit 103 may be incorporated into a ring worn on the user's finger (or any other suitable type of jewellery), incorporated into a thimble worn on the end of a finger, or attached to a band worn around the user's wrist. In certain embodiments, the motion unit may be incorporated into a “smart” device, for example a “smartwatch”, “smart-glasses”, and the like. Alternatively, the motion unit 103 may comprise a hand-held device.

In certain embodiments, the motion unit may be attached to a body part whose motion correlates relatively closely with motion of the input object when the user applies an input. For example, if the input is applied using a finger or stylus, the motion unit may be worn around the wrist of the hand having the finger used to apply the input, or that is holding the stylus. In other embodiments, the motion unit may be attached to a body part whose motion is relatively independent of motion of the input object when the user applies an input. For example, if the input is applied using a finger or stylus, the motion unit may be worn around the wrist of the hand not having the finger used to apply the input, or that is not holding the stylus.

In certain embodiments, in order to further enhance user interaction with the device 101, two or more motion units 103 may be provided. For example, a user may wear a motion unit around each wrist. The receiver 113 may receive motion data from each motion unit 103, and the processor 115 may perform an operation depending on a touch input and determined characteristics of the motion represented by the motion data of each motion unit.

The motion sensor 109 may comprise any suitable type of sensor for measuring motion. For example, the motion sensor 109 may comprise one or more accelerometers and/or one or more gyroscopes for measuring acceleration (e.g. linear acceleration). In some exemplary embodiments, the motion sensor 109 may comprise a single three-axis accelerometer for measuring acceleration. In other exemplary embodiments, the motion sensor 109 may comprise a single three-axis accelerometer and a gyroscope for measuring linear acceleration. The accelerometers may be of any suitable type, for example a piezoelectric accelerometer, piezoresistive accelerometer, capacitive accelerometer, Micro Electro-Mechanical System (MEMS) accelerometer, and the like.

In certain embodiments, the motion sensor 109 may be configured for measuring motion with respect to one or more linearly independent (e.g. orthogonal) axis. For example, the motion sensor 109 may comprise one or more accelerometers and/or gyroscopes for measuring acceleration (e.g. linear acceleration) about one or more axis (e.g. X, Y and Z axis). Alternatively, or additionally, the motion unit 103 may be configured for measuring the acceleration magnitude, independent of direction. For example, the motion sensor 109 may comprise a sensor for directly measuring the acceleration magnitude, or the motion unit may comprise a processor (not shown) for computing the acceleration magnitude from the components of a measured acceleration vector.

The motion sensor 109 may generate motion data comprising, for example, a sequence of values indicating the motion (e.g. linear acceleration) of the motion unit 103 at certain (e.g. regular) time points. The values may be generated, for example, by sampling the measured motion at a certain frequency, for example 100 Hz. The resulting motion data may be expressed, for example, as a sequence of vector values and/or a sequence of magnitude values.

The transmitter 111 of the motion unit 103 and the receiver 113 of the device 101 may comprise any suitable means for forming a wired or wireless communication channel between the motion unit 103 and the device 101. For example, the communication channel may be formed based on any suitable communication technique, for example Near Field Communication (NFC), Bluetooth, WiFi, and the like. The transmitter 111 obtains the motion data from the motion sensor 109, and transmits the motion data in any suitable format to the device 101. The motion data may be transmitted together with an identification that is unique to the particular motion unit 103 that has generated the motion data. This allows the device 101 to identify which motion unit 103 has generated the motion data, and allows the device 101 to distinguish between motion data received from different motion units 103.

The processor 115 receives touch input data (referred to below simply as input data) from the input unit 107. The input data comprises information relating to the inputs applied to the input unit 107. The processor 115 may perform one or more operations based on the received input data. For example, the processor may perform a certain operation in relation to a currently executing user application in response to a certain input applied to the input unit 107. As described above, the operation performed may depend not only on the input applied to the input unit 107, but also on motion of the motion unit 103 before, during and/or after the input was applied to the input unit 107. For example, the result of the operation (e.g. the way in which the processor 115 processes the operation) may depend on motion of the motion unit 103 before, during and/or after the input was applied to the input unit.

In addition to receiving the input data from the input unit 107, the processor 115 also receives motion data from the motion unit 103 via the receiver 113. The motion data comprises information relating to the motion of the motion unit 103. Depending on the form of the motion data received from the motion unit 103, the processor 115 may process the received motion data to convert the motion data to a different form suitable for further processing. For example, in certain embodiments, if the received motion data comprises acceleration data and gyroscope data, then the processor 115 may obtain or derive data representing linear acceleration from the received motion data. In another example, the processor may compute acceleration magnitude values from received acceleration vector values. In further examples, if the received motion data comprises acceleration values, velocity and/or position values may be computed, for example by integration. One or more further physical quantities may be derived from these values, for example energy values, and the like.

In certain embodiments, the processor 115 may perform various pre-processing on the motion data, or data obtained or derived from the motion data, for example filtering, smoothing, averaging, and the like. In one example, the processor 115 filters the motion data by applying an N-sample (e.g. N=2, 3, 4, 5, . . . ) moving average filter to smooth the data and remove noise.

Whether or not pre-processing is applied to the motion data, the processor 115 analyses the motion data to determine one or more characteristics of the motion represented by the motion data. For example, the characteristics of motion may include (i) one or more types of the motion (e.g. motion comprising a predetermined pattern, for example a shake, linear motion, non-linear motion, rotation motion, random motion, periodic motion and the like), (ii) one or more physical properties (e.g. direction, speed, velocity, acceleration, energy, and the like) of the motion, and/or (iii) one or more statistical values (e.g. average, mode, lowest, highest, range, cumulative value, and the like) derived from one or more physical properties of the motion. The characteristics of orientation may include orientation relative to a reference direction, which may comprise a fixed reference direction (e.g. a direction related to the direction of gravity), and/or a direction related to the orientation of the device 101 (e.g. a direction normal to a touch surface of the device 101).

In certain embodiments, the processor 115 may classify the motion of the motion unit 103 based on the analysis of the motion data. The classification may be performed using any suitable technique, for example using a decision-tree classifier. For example, in certain embodiments, classification may be performed by recognizing a specific gesture (e.g. the tracing of a shape in the air) before a touch input applied to the input unit 107.

The processor 115 performs an operation depending on the received input data and the analysis of the received motion data. For example, when the processor 115 performs an operation based on the received input data, the processor 115 may process the operation according to the analysis of the motion data (for example according to the characteristics of the motion and/or the classification of the motion). The operation performed may also depend on the timing of the motion relative to the touch input applied to the input unit. Various examples will be described in greater detail below.

In certain embodiments, it may be necessary to take into account any difference in orientation between the motion unit 103 and the device 101. It may also be necessary to compensate a measured motion to take into account the effects of gravity. For example, an accelerometer measures acceleration relative to the orientation of the sensor. This measurement is subject to a bias that results from the earth's gravitational field. In order to utilise the accelerometer to capture motion relative to a touch surface, this coordinate system may require transformation.

In a first example, the motion unit 103 and the device 101 may each be configured to determine the direction of gravity with respect to their own respective internal coordinate systems. The motion unit 103 transmits its own determined gravity direction to the device 101. The device 101 then calculates a difference between the gravity direction received from the motion unit 103 with its own determined gravity direction to determine an orientation difference between the respective coordinate systems of the motion unit 103 and the device 101. This difference may then be used to compensate for the difference in orientations when performing the comparison.

The direction of gravity may be determined using any suitable technique, for example based on using a linear accelerometer to measure the linear acceleration direction during a calibration period when the motion unit 103 or device 101 is held at rest, and one or more gyroscopes to track subsequent changes in orientation of the motion unit 103 or device 101. The determined gravity direction may be used to compensate any measured motion, if necessary.

In a second example, the orientation of the motion unit 103 with respect to a touch surface of the device 101 may be estimated using Principle Component Analysis (PCA). In particular, when the user applies certain gestures to the touch surface (e.g. a drag gesture), the directions along which the motion unit 103 moves will tend to be constrained, as the user remains in contact with the touch surface during the gesture. Accordingly, the two main directions of acceleration experienced by the motion sensor 109 correspond approximately to the plane of the touch surface.

In this case, the transformation of the input unit (e.g. touch sensor) coordinates may be performed, for example, using dimensionality reduction techniques. Dimensionality reduction techniques are computational tools used to transform a coordinate system with d dimensions to a different coordinate system with d′ dimensions, for example according to a heuristic algorithm, or any other suitable technique. The transformed coordinate system may have a smaller dimensionality (i.e. d>d′), but retains some characteristics of the original coordinate system.

One such technique is PCA. According to this technique, a number of samples from an accelerometer may be used to estimate their principal components during one or more touch gestures. In PCA, these principal components are those directions, relative to the sensor, on which most of the measured variance occurs. The first two principal components lie approximately within the plane of the touch surface if estimated using samples recorded at the time the gesture is performed. These principal components may then be utilised to project the data captured over the course of the gesture, or smaller parts of it, into a coordinate system relative to the orientation of the device.

The skilled person will appreciate that, equivalently, the coordinate system of the motion unit 103, rather than the coordinate system of the input unit 107, may be transformed, or the coordinate systems of both the motion unit 103 and the input unit 107 may be transformed.

Various examples of enhanced user interactions provided by exemplary embodiments of the present invention will now be described. Exemplary applications of some of these interactions will be described with reference to a painting application executed by the processor 115. In these examples, it is assumed that the motion unit 103 is incorporated into a smart watch worn around the user's wrist and that the user applies touch inputs using a finger. However, the skilled person will appreciate that the present invention is not limited to these specific examples. For example, the invention may be applied to a game or gaming application and the motion unit 103 may comprise a gaming controller.

The painting application allows the user to draw or paint on a virtual canvas using various tools. For example, the user may select a brush tool and apply a brush stroke to the canvas by using a touch input to trace a line across the touch surface. Similarly, the user may select a spray can tool and apply spray paint to the canvas by using a touch input to trace a line across the touch surface. The user may select an eraser tool to erase paint applied to the canvas. The user may also cut objects from the canvas and paste objects to the canvas.

In various examples, an operation may be performed depending on one or more characteristics of motion of the motion unit: (i) at the time a user input is initiated (e.g. at the time an input object makes initial contact with an input surface for applying a touch input), (ii) during a first time period (e.g. a time period having a predetermined duration) immediately preceding initiation of a user input (e.g. a period ending upon initiation of the user input), (iii) at the time a user input is terminated (e.g. at the time an input object is released from the input surface after applying a touch input), (iv) during a second time period (e.g. a time period having a predetermined duration) immediately following termination of a user input (e.g. a period beginning upon termination of the user input), and/or (v) during a third time period in which the user input occurs. The third time period may be a time period having a predetermined duration, or may be a period corresponding to the user input (e.g. a period beginning upon initiation of the user input and ending upon termination of the user input).

The skilled person will appreciate that an operation may be performed depending on any combination of examples (i) to (v) above. For example, an operation may be performed depending on characteristics of the motion of the motion unit during period both before and after initiation of the user input.

One or more characteristics of motion of the motion unit 103 may take a discrete or fixed set of values, while one or more other characteristics of motion of the motion unit 103 may take a continuous range of values. Furthermore, a discrete set of operations may be performed, while a certain operation may be performed according to one or more parameters, which may each take a discrete or fixed set of values, or a continuous range of values.

In certain embodiments, the dependence between characteristics of motion of the motion unit 103 and the operation performed may be defined by a mapping, for example such that values of motion characteristics may be mapped to operations or operation parameter values according to any suitable mapping. For example, a set of N motion patterns may be mapped in a one-to-one relationship to N distinct operations. As another example, continuous values of orientation and velocity may be mapped according to respective functions to values of two respective continuous-valued operation parameters.

In certain embodiments, in cases where one or more characteristics of motion of the motion unit 103 vary over time, an operation performed, or the values of one or more operation parameters may also vary over time accordingly.

In certain embodiments, enhanced interactions may be divided into various classes. For example, one class of interactions may be referred to as “before a touch event”, in which an effect is applied to an action (e.g. resulting from a touch input) based on how an input object approaches the touch surface before the action. For example, an effect may be applied according to the velocity with which the input object approaches the touch surface and/or the angle of the approach. In this case, the processor 115 applies the effect based on the velocity and/or orientation of the motion unit 103, as determined from the motion data, in a period prior to the action.

For example, in the painting application, when the brush tool is selected, the velocity of the approach may define the shape of the beginning of the brush stroke. For example, the slower the user's finger approaches the touch surface, the more the stroke fades in. Conversely, the quicker the user's finger approaches the touch surface, the more distinct the stroke is at the start.

In this example, if a finger of the user's right hand is used to apply the touch input, then the smart watch comprising the motion unit 103 may be worn around the user's right wrist. Conversely, if a finger of the user's left hand is used to apply the touch input, then the smart watch comprising the motion unit 103 may be worn around the user's left wrist. In this way, the motion of the motion unit 103 correlates relatively closely to the motion of the user's finger during the approach.

Another class of interactions may be referred to as “during a touch or drag event”, in which an effect is applied to an action based on how an input object is moved or orientated while in contact with the touch surface.

For example, in the painting application, when the brush tool is selected, the orientation of the user's finger with respect to the screen may determine the brush size. In this case, as the user changes the orientation of their finger, the orientation of the user's wrist, and hence the orientation of the motion unit 103, will also tend to change. Accordingly, the motion unit 103, even though comprised in a smart watch worn around the user's wrist, may be used to indirectly measure the orientation of the user's finger. In this example, the user may change the orientation of their finger while applying the brush stroke to adjust the brush size during the stroke.

Another class of interactions may be referred to as “after a release event”, in which an effect is applied to an action after an input object has left the surface, or as it leaves the surface. For example, an effect may be applied according to the velocity with which the input object leaves the touch surface and/or the angle of the release.

For example, in the painting application, the velocity of the release may determine the shape of the end of the brush stroke. For example, the slower the user's finger leaves the touch surface, the more tapered the end of the stroke is. Conversely, the quicker the user's finger leaves the touch surface, the more abrupt the end of the stroke is.

Another class of interactions is based on the user performing a certain pattern of movement (which may be referred to as a “motion gesture”) in the period before an input object makes contact with the touch surface or in the period after the input object is released from the touch surface. The type and characteristics of the motion gesture may determine which effect is applied and/or how the effect is applied, once the input object has made contact with the input surface, or once the input object is released from the input surface.

For example, in the painting application, when the spray can tool is selected, the user may perform a motion gesture in the form of a shaking gesture, similar to shaking a physical spray can, prior to applying spray paint to the canvas. The intensity or energy of the shaking gesture may be determined and stored as a value that is used to determine the size and strength of the spraying effect (e.g. the density of spray droplets and/or the size of the spray area) when the spray paint is applied. In one example, the size and strength of the spraying effect may diminish over time as the spray paint is applied, for example until the effect is fully depleted after a certain period of time (e.g. five seconds). The user may replenish the size and strength of the spraying effect at any time by repeating the shaking gesture.

Another class of interactions is based on the user performing one or more motion gestures to apply a certain effect to, or to change a property of, an on-screen object selected by a user input.

For example, in the painting application, a first user input may be performed by the user to select an object (e.g. a stroke) applied to the canvas, and a first motion gesture (e.g. a “cupping” gesture) may be performed to cut the selected object and store the cut object in a buffer. The user may then perform a second motion gesture (e.g. a reverse-cupping gesture) to paste the buffered object to the canvas at a certain position (e.g. selected by a second user input).

In certain examples, a property of a motion gesture (e.g. the speed or distance of the motion gesture) may influence how an effect is applied on screen. For example, in the painting application, a motion gesture in the form of a “scrubbing” gesture may be performed by the user to perform an erase function at a location selected by a user input. The intensity of the scrubbing gesture may be used to determine the degree of erasing applied. The intensity of the scrubbing gesture may be determined, for example, by counting the number of changes in movement direction along a certain axis (e.g. X-axis) during a certain time window.

In another example, the user may perform a motion gesture, for example a rotation gesture, in order to modify a stroke size. In this case, the motion gesture may be applied by the hand of the user that is used to applying the touch input to draw the stroke. Alternatively, the user may use one of their hands to apply the touch to draw the stroke, and may use their other hand to perform the motion gesture.

In yet another example, when the user interacts with the device in a relatively high-energy manner (e.g. involving movements of relatively high speed and/or relatively high frequency changes in movement direction), the processor 115 may modify the way in which an application program reacts to user inputs. For example, the occurrence of relatively high energy user interaction indicates that the user is applying many inputs in quick succession, which may result in an input error. The processor 115 may hide certain user interface elements (e.g. buttons) associated with high-consequence actions, or may require the user to perform a greater number of steps to perform a high-consequence action. A high-consequence action may comprise, for example, an action that cannot be undone, or an action having relatively important consequences. Accordingly, during periods of high energy user interaction, the probability of the user accidentally performing a high-consequence action is reduced.

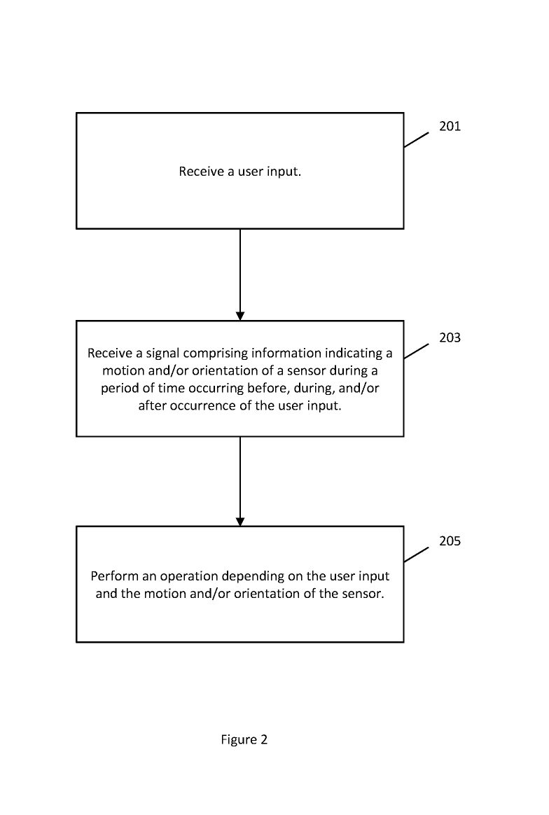

FIG. 2 illustrates a method according to an exemplary embodiment of the present invention. For example, the method may be carried out by the device 101 illustrated in FIG. 1. In a first step 201, a user input is received. In a next step 203, a signal is received comprising information indicating a motion and/or orientation of a sensor (for example, the motion unit 103 illustrated in FIG. 1) during a period of time occurring before, during, and/or after occurrence of the user input. In a next step 205, an operation is performed depending on the user input and the motion and/or orientation of the sensor.

It will be appreciated that embodiments of the present invention can be realized in the form of hardware, software or a combination of hardware and software. Any such software may be stored in the form of volatile or non-volatile storage, for example a storage device, ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement embodiments of the present invention. Accordingly, embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

While the invention has been shown and described with reference to certain embodiments thereof, it will be understood by those skilled in the art that various changes in form and detail may be made therein without departing from the scope of the invention as defined by the appended claims.

1. A method, for a device, for enhancing user interaction with the device, the method comprising the steps of:
receiving a user input, wherein the user input comprises one or more of: a touch input applied to the device by an input object; a sensed proximity between the device and the input object; and actuation of a physical input element of the device by the input object;
receiving a signal comprising information indicating a motion and/or orientation of a sensor during a period of time occurring before, during, and/or after occurrence of the user input, wherein the sensor is separate from the device; and
performing an operation depending on the user input and the motion and/or orientation of the sensor.

2. A method according to claim 1, wherein the user input comprises one or more touch inputs applied to a touch sensitive surface of the device.

3. A method according to claim 1 or 2, wherein the method comprises the further step of determining one or more characteristics of the motion and/or orientation of the sensor using the information comprised in the received signal.

4. A method according to claim 3, wherein the one or more characteristics of the motion comprise one or more of: a type of the motion and/or orientation; a physical property of the motion and/or orientation; and a statistical value derived from a physical property of the motion and/or orientation.

5. A method according to claim 4, wherein the physical property of the motion comprises one or more of: direction; speed; velocity; acceleration; and energy of the motion.

6. A method according to claim 4 or 5, wherein the statistical value comprises one or more of: an average value; a modal value; a lowest value; a highest value; a range value; and a cumulative value.

7. A method according to claim 4, 5 or 6, wherein the type of the motion comprises one or more of: motion comprising a predetermined pattern; linear motion; non-linear motion; rotation motion; random motion; and periodic motion.

8. A method according to any of claims 3 to 7, wherein the one or more characteristics of the orientation comprises an orientation relative to a reference direction.

9. A method according to claim 8, wherein the reference direction comprises a fixed reference direction.

10. A method according to claim 9, wherein the fixed reference direction comprises a direction related to the direction of gravity.

11. A method according to claim 8, wherein the reference direction comprises a direction related to the orientation of the device.

12. A method according to claim 11, wherein the direction related to the orientation of the device comprises a direction normal to a touch sensitive surface of the device.

13. A method according to any of claims 3 to 12, wherein the step of performing the operation comprises performing the operation depending on one or more characteristics of the motion and/or orientation of the sensor during a first time period ending upon initiation of the user input.

14. A method according to any of claims 3 to 13, wherein the step of performing the operation comprises performing the operation depending on one or more characteristics of the motion and/or orientation of the sensor at the time the user input is initiated.

15. A method according to any of claims 3 to 14, wherein the step of performing the operation comprises performing the operation depending on one or more characteristics of the motion and/or orientation of the sensor during a second time period beginning upon termination of the user input.

16. A method according to any of claims 3 to 15, wherein the step of performing the operation comprises performing the operation depending on one or more characteristics of the motion and/or orientation of the sensor at the time the user input is terminated.

17. A method according to any of claims 3 to 17, wherein the step of performing the operation comprises performing the operation depending on one or more characteristics of the motion and/or orientation of the sensor during a third time period in which the user input occurs.

18. A method according to claim 13, 15 or 17, wherein one or more of the first, second and third time periods comprises a time period having a predetermined duration.

19. A method according to claim 17, wherein the third time period begins upon initiation of the user input and ends upon termination of the user input.

20. A method according to any preceding claim, comprising the further step of classifying the motion and/or orientation of the sensor.

21. A method according to claim 20, wherein the step of performing the operation comprises performing the operation depending on the classification of the motion and/or orientation of the sensor.

22. A method according to any preceding claim, wherein the operation comprises modifying a Graphical User Interface (GUI).

23. A method according to claim 22, wherein the step of modifying the GUI comprises modifying the GUI when an energy value of motion occurring during a time period during which the user input occurs exceeds a threshold.

24. A method according to any preceding claim, wherein the operation comprises an operation in an art application.

25. A method according to claim 24, wherein the operation comprises applying or modifying a graphical entity on a virtual canvas using a virtual art tool, wherein one or more parameters associated with the tool depends on the one or more characteristics of the motion and/or orientation of the sensor.

26. A method according to any preceding claim, wherein the user input comprises selecting a location in a GUI, and wherein the operation comprises an operation performed on a GUI object in relation to the selected located.

27. A method according to claim 26, wherein the operation comprises one or more of:
cutting or copying an object at the selected location; and pasting an object to the selected object.

28. A method according to any preceding claim, wherein the user input comprises an input for performing a first operation, and wherein the operation comprises a modified version of the first operation.

29. A method according to any preceding claim, wherein the operation comprises an operation in a game.

30. A device for enhancing user interaction with the device, the device comprising:
an input unit for receiving a user input, wherein the user input comprises one or more of: a touch input applied to the device by an input object; a sensed proximity between the device and the input object; and actuation of a physical input element of the device by the input object;
a receiver for receiving a signal comprising information indicating a motion and/or orientation of a sensor during a period of time occurring before, during, and/or after occurrence of the user input, wherein the sensor is separate from the device; and
a processor for performing an operation depending on the user input and the motion and/or orientation of the sensor.

31. A device according to claim 30, wherein the user input comprises one or more touch inputs applied to a touch sensitive surface of the device.

32. A device according to claim 30 or 31, wherein the process is configured for determining one or more characteristics of the motion and/or orientation of the sensor using the information comprised in the received signal.

33. A device according to claim 33, wherein the one or more characteristics of the motion comprise one or more of: a type of the motion and/or orientation; a physical property of the motion and/or orientation; and a statistical value derived from a physical property of the motion and/or orientation.

34. A device according to claim 33, wherein the physical property of the motion comprises one or more of: direction; speed; velocity; acceleration; and energy of the motion.

35. A device according to claim 33 or 34, wherein the statistical value comprises one or more of: an average value; a modal value; a lowest value; a highest value; a range value; and a cumulative value.

36. A device according to claim 33, 34 or 35, wherein the type of the motion comprises one or more of: motion comprising a predetermined pattern; linear motion; non-linear motion; rotation motion; random motion; and periodic motion.

37. A device according to any of claims 32 to 36, wherein the one or more characteristics of the orientation comprises an orientation relative to a reference direction.

38. A device according to claim 37, wherein the reference direction comprises a fixed reference direction.

39. A device according to claim 38, wherein the fixed reference direction comprises a direction related to the direction of gravity.

40. A device according to claim 37, wherein the reference direction comprises a direction related to the orientation of the device.

41. A device according to claim 40, wherein the direction related to the orientation of the device comprises a direction normal to a touch sensitive surface of the device.

42. A device according to any of claims 32 to 41, wherein the processor is configured for performing the operation by performing the operation depending on one or more characteristics of the motion and/or orientation of the sensor during a first time period ending upon initiation of the user input.

43. A device according to any of claims 32 to 42, wherein the processor is configured for performing the operation by performing the operation depending on one or more characteristics of the motion and/or orientation of the sensor at the time the user input is initiated.

44. A device according to any of claims 32 to 43, wherein the processor is configured for performing the operation by performing the operation depending on one or more characteristics of the motion and/or orientation of the sensor during a second time period beginning upon termination of the user input.

45. A device according to any of claims 32 to 44, wherein the processor is configured for performing the operation by performing the operation depending on one or more characteristics of the motion and/or orientation of the sensor at the time the user input is terminated.

46. A device according to any of claims 32 to 46, wherein the processor is configured for performing the operation by performing the operation depending on one or more characteristics of the motion and/or orientation of the sensor during a third time period in which the user input occurs.

47. A device according to claim 42, 44 or 46, wherein one or more of the first, second and third time periods comprises a time period having a predetermined duration.

48. A device according to claim 46, wherein the third time period begins upon initiation of the user input and ends upon termination of the user input.

49. A device according to any of claims 30 to 48, wherein the processor is configured for classifying the motion and/or orientation of the sensor.

50. A device according to claim 49, wherein the processor is configured for performing the operation by performing the operation depending on the classification of the motion and/or orientation of the sensor.

51. A device according to any of claims 30 to 50, wherein the operation comprises modifying a Graphical User Interface (GUI).

52. A device according to claim 51, wherein the processor is configured for modifying the GUI by modifying the GUI when an energy value of motion occurring during a time period during which the user input occurs exceeds a threshold.

53. A device according to any of claims 30 to 52, wherein the operation comprises an operation in an art application.

54. A device according to claim 53, wherein the operation comprises applying or modifying a graphical entity on a virtual canvas using a virtual art tool, wherein one or more parameters associated with the tool depends on the one or more characteristics of the motion and/or orientation of the sensor.

55. A device according to any of claims 30 to 54, wherein the user input comprises selecting a location in a GUI, and wherein the operation comprises an operation performed on a GUI object in relation to the selected located.

56. A device according to claim 55, wherein the operation comprises one or more of:
cutting or copying an object at the selected location; and pasting an object to the selected object.

57. A device according to any of claims 30 to 56, wherein the user input comprises an input for performing a first operation, and wherein the operation comprises a modified version of the first operation.

58. A device according to any of claims 30 to 57, wherein the operation comprises an operation in a game.

59. A system comprising:
a device according to any of claims 30 to 58; and
a sensor unit comprising: a sensor for measuring motion and/or orientation; and a transmitter for transmitting a signal comprising information indicating a motion and/or orientation of the sensor.

60. A system according to claim 59, wherein the sensor unit is adapted to be attached to a body part of a user, or held by the user.

61. A system according to claim 60, wherein the sensor unit comprises a smart watch.

62. A system according to claim 59, wherein the sensor unit is comprised in an input object for applying a user input to the device.
